(19) United States
(12) Patent Application Publication
(10) Pub. No.: US 2014/0265300 A1
(43) Pub. Date: Sep. 18, 2014

(54) SMART ANTI-FRAUD SHIPPING LABELS

(71) Applicant: Sarada Prasanna Jena, Cupertino, CA (US)

(72) Inventor: Sarada Prasanna Jena, Cupertino, CA (US)

(73) Assignee: EBAY INC., SAN JOSE, CA (US)

(21) Appl. No.: 13/801,787

(22) Filed: Mar. 13, 2013

(51) Int. Cl. B42D 15/00

(52) U.S. Cl. CPC B42D 15/00
USPC 283/67; 283/81

(57) ABSTRACT

A system and method for an antifraud shipping label system are described. The antifraud shipping label system includes a stamp generator and a stamp transaction registration module. The stamp generator generates stamps corresponding to a seller registered with an online marketplace application. Each stamp has a unique identifier with respect to the online marketplace application. The stamps are mailed to the seller. The stamp transaction registration module generates a presentation in which the identifiers that correspond to the stamps mailed to the seller are each partially displayed within the presentation. The stamp transaction registration module receives a selection of a partially displayed identifier as a selection made the seller, and associate shipping information from a transaction of the seller in the online marketplace application with the entirety of the partially displayed identifier selected by the seller.

### TECHNICAL FIELD

This application relates generally to the field of computer technology and, in a specific example embodiment, a method and system for generating antifraud shipping labels.

### BACKGROUND

Online marketplaces include many sellers listing items for sale. Buyers buy these items, and sellers ship the items to the buyers upon receipt of payment. The shipping process typically includes the seller packing the item in a box, sealing it up, bringing it to the post office, filling out the necessary forms, weighing the package to calculate the postage, paying for the postage, taping the stamp on the box, and finally dropping the box in the parcel deposit area. Because this shipping process entails many steps, it can become a deterrent for sellers to list, sell, and ship their items.

Furthermore, hackers gaining control over the seller's account can take advantage and print unauthorized shipping labels that generate financial losses to online marketplaces, because these online marketplaces absorb the loss by compensating sellers for such unauthorized transactions.

### BRIEF DESCRIPTION OF THE DRAWINGS

The present disclosure is illustrated by way of example, and not by way of limitation, in the figures of the accompanying drawings in which:

FIG. 1 is a network diagram depicting a network system, according to one embodiment, having a client-server architecture configured for exchanging data over a network.

FIG. 2 shows a block diagram illustrating one example embodiment of a marketplace application.

FIG. 3 shows a block diagram illustrating one example embodiment of an antifraud shipping label application.

FIG. 4 shows a ladder diagram illustrating one example embodiment of an operation of antifraud shipping labels.

FIG. 5A shows a flow diagram illustrating one example embodiment of a method for using antifraud shipping labels.

FIG. 5B shows a flow diagram illustrating one example embodiment of a method for using antifraud shipping labels.

FIG. 6 shows a diagrammatic representation of machine in the example form of a computer system within which a set of instructions may be executed to cause the machine to perform any one or more of the methodologies discussed herein.

### DETAILED DESCRIPTION

Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for an antifraud shipping label system are described. The antifraud shipping label system includes a stamp generator and a stamp transaction registration module. The stamp generator generates stamps corresponding to a seller who may be registered with an online marketplace application. Each stamp is identified by an identifier that is unique with respect to (e.g., within) the online marketplace application. Accordingly, each identifier uniquely identifies its corresponding stamp to the online marketplace application.

The stamps are mailed to the seller. The stamp transaction registration module generates a partial display of the identifiers corresponding to the stamps mailed to the seller, receives a selection of a partially displayed identifier from the seller, and associates shipping information from a transaction of the seller in the online marketplace application with the identifier corresponding to the selection of the partially displayed identifier from the seller.

### System Architecture

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as peer-to-peer or distributed network environments.

A data exchange platform, in an example form of a marketplace application 120 and an antifraud shipping label application 122, may provide server-side functionality, via a network 104 (e.g., the Internet) to one or more clients. The one or more clients may include users that utilize the network system 100 and, more specifically, the marketplace application 120 and the antifraud shipping label application 122, to exchange data over the network 104. These transactions may include transmitting, receiving (communicating), and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments, the client machines 110, 112, or third party server 130 may be associated with a buyer, a seller, a third party electronic commerce platform, a payment service provider, a shipping service provider, or a financial institution system, with each in communication with the a networked system 102 and optionally each other. The buyers and sellers may be any one of individuals, merchants, or service providers.

Turning specifically to the marketplace application 120 and the antifraud shipping label application 122, an application program interface (API) server 114 and a web server 116 are coupled to, and provide programmatic and web interfaces respectively to, one or more application servers 118. The application server 118 hosts one or more marketplace applications 120 and the antifraud shipping label application 122. The application server 118 is, in turn, shown to be coupled to one or more database servers 124 that facilitate access to one or more databases 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or 3^{rd} party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the antifraud shipping label application 122 includes a system and a method for generating a set of physical shipping labels to a shipper or a seller of the marketplace application 120. The shipping labels may include a set of machine-readable identifiers such as a QR code, bar code, or a set of numbers and letters. The seller selects a shipping label for usage using the antifraud shipping label application 122 and pastes the identified physical shipping label on a package. The seller takes the package to a shipping carrier who scans the physical shipping label to determine its validity and retrieve pertinent shipping information such as names and addresses. The shipping carrier then generates an actual shipping label corresponding to the shipping carrier and communicates information of the shipping label, such as the shipping carrier tracking number, back to the antifraud shipping label application 122. The antifraud shipping label application 122 is described in more detail below with respect to FIG. 3.

FIG. 2 shows a block diagram illustrating one example embodiment of the marketplace application 120. The marketplace application 120 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 120 is shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

FIG. 3 shows a block diagram illustrating one example embodiment of the antifraud shipping label application 122. The antifraud shipping label application 122 may include an antifraud stamps generator 302, an antifraud stamps transaction registration module 304, a shipping carrier antifraud stamps validation module 306, and a shipping carrier tracking number module 308.

The antifraud stamps generator 302 generates one or more stamps corresponding to a seller registered with the online marketplace application 120. Each stamp includes an identifier unique to the online marketplace application 120. The stamp may include, for example, a machine-readable code and corresponding alphanumeric characters. In one embodiment, the stamp may display only the machine-readable code and corresponding alphanumeric characters and not include any other information such as shipping information or transaction information from the online marketplace application 120. The stamps include adhesive labels or stickers so that the seller can apply the stamps to packages or boxes.

The stamps are mailed to the seller. For example, the antifraud stamps generator 302 generates and prints stamps that are physically mailed or delivered to the seller.

The antifraud stamps transaction registration module 304 generates a partial display of the identifiers corresponding to the stamps mailed to the seller. For example, when the seller logs in the antifraud shipping label application 122, the antifraud stamps transaction registration module 304 displays only the last few numbers or letters of the identifier of each stamp for the seller to select.

In one embodiment, the antifraud stamps transaction registration module 304 may implement the following constraints to prevent fraud: changes of address may not be allowed once an order has been placed. Seller will not be able to change “ship from address” once a label has been printed and order information is sent to the shipping carrier.

The antifraud stamps transaction registration module 304 receives a selection of a partially displayed identifier from the seller (e.g., seller selects to use stamp ending in “3241”) and associates shipping information from a transaction of the seller in the online marketplace application 120 with the identifier corresponding to the selection of the partially displayed identifier from the seller. For example, the shipping information may include the name and addresses of the shipping origin and destination corresponding to the seller and buyer of the online marketplace. The shipping information may further include information about the item being shipped such as the weight, dimensions, a transaction value of the item, and so forth.

In another embodiment, the shipping information may include a preferred or preselected shipping service (e.g., two-day shipping, parcel shipping), insurance coverage (e.g., decline insurance, purchase extra insurance), other restrictions such as a delivery signature required or waived, delivery by a certain time (e.g., end of business day).

In one embodiment, the antifraud stamps transaction registration module 304 identifies the stamp corresponding to the identifier received from the shipping carrier and removes the identifier received from the shipping carrier from display to the seller.

The shipping carrier antifraud stamps validation module 306 may receive an identifier of a stamp from a shipping carrier. For example, the identifier may include letters and numbers corresponding to the machine-readable code of the stamp pasted on a package by the seller. The shipping carrier antifraud stamps validation module 306 then validates the identifier received from the shipping carrier by verifying that the identifier has been elected by the seller and not already been used for another transaction. For example, the shipping carrier antifraud stamps validation module 306 validates the identifier by determining whether the identifier received from the shipping carrier has been selected by the seller for the transaction and whether the identifier received from the shipping carrier has already been identified in another transaction or has other been used in another transaction.

The shipping carrier antifraud stamps validation module 306 retrieves the shipping information associated with the received identifier. In one embodiment, the shipping carrier antifraud stamps validation module 306 retrieves the shipping information from the online marketplace application 120. For example, the shipping carrier accesses the transaction between the seller and the buyer on the online marketplace application 120 and obtains the names of the parties, shipping addresses, and other pertinent information related to the shipping of the package such as shipping services, insurance elections, and restrictions. The shipping carrier antifraud stamps validation module 306 communicates the retrieved shipping information to the shipping carrier.

In another embodiment, the shipping carrier antifraud stamps validation module 306 receives shipping charges information from the shipping carrier corresponding to the identifier received from the shipping carrier and communicates the shipping charges information to the online marketplace application 120 to update a financial account of the seller. For example, an amount corresponding to the shipping charges associated the stamp being used may be automatically deducted from the seller's financial account.

The shipping carrier tracking number module 308 receives tracking information associated with the identifier from the shipping carrier. For example, the tracking information identifies a shipping status of the package from the shipping carrier. The shipping carrier tracking number module 308 may forward and communicate the tracking information corresponding to the identifier of a stamp to the seller associated with the stamp.

### Example Scenario

FIG. 4 is a ladder diagram illustrating an example of an operation of the antifraud shipping label application 122 that integrates an operation of the online marketplace application 120. One purpose is to prevent unauthorized usage of shipping label printing from the online marketplace account of the seller when the account of the seller has been hacked or otherwise compromised.

A seller 402 registers and provides seller information with an online marketplace and antifraud shipping label application 404 in operation 408. The seller information may include the seller 402's name, address, shipping information, user ID, password, items for sale on the online marketplace. The marketplace and antifraud shipping label application 404 generates physical stamps at operation 410. The physical stamps are mailed at an address of the seller 402 corresponding to the seller information provided in operation 408. The marketplace and antifraud shipping label application 404 displays only the last few numbers and letters of each stamp to be used at operation 416. At operation 414, the seller 402 receives an order from a buyer on the online marketplace. The seller 402 prepares a package containing the item for shipping. At operation 418, seller 402 selects a stamp to be purchased by the seller 402 by identifying the last few numbers of the stamp. The marketplace and antifraud shipping label application 404 confirms the selection of the stamp at operation 420. The seller 402 then applies the selected stamp to the package at operation 422 and provides the package to a shipping carrier 406 at operation 424. The shipping carrier 406 identifies the stamp on the package by scanning a barcode or QR code on the stamp at operation 426. A server of the shipping carrier 406 provides the barcode numbers from the stamp to the marketplace and antifraud shipping label application 404 at operation 428. At operation 430, the marketplace and antifraud shipping label application 404 validates the barcode numbers from the stamp and confirms the validity of the stamp to the shipping carrier 406 at operation 432 by providing shipping information to the server of the shipping carrier 406.

Upon receiving shipping information and confirmation of the validity of the stamp, the server of the shipping carrier 406 generates a shipping label corresponding to the shipping carrier 406 at operation 434. The shipping label may include a shipping tracking number. The server of the shipping carrier 406 may communicate the tracking information back to the marketplace and antifraud shipping label application 404 at operation 436. In one embodiment, the marketplace and antifraud shipping label application 404 may forward the tracking information to the seller 402.

FIG. 5A shows a flow diagram illustrating one example embodiment of a method 500 for using antifraud shipping labels. The method 500 may be performed, in whole or in part, by the antifraud shipping label application 122, using modules discussed above with respect to FIG. 3.

At operation 502, the antifraud shipping label application 122 generates and mails antifraud stamps to a seller 402 of an online marketplace. At operation 504, the antifraud shipping label application 122 generates a partial display of the identifiers for each unused stamp. At operation 506, the antifraud shipping label application 122 receives a selection of a stamp to use from the seller 402 for a transaction of the online marketplace. At operation 508, the antifraud shipping label application 122 receives an identifier from a shipping carrier server. At operation 510, the antifraud shipping label application 122 determines whether the stamp corresponding to the identifier is valid. If the stamp is determined to be valid, the antifraud shipping label application 122 retrieves shipping information associated with the stamp corresponding to the transaction at operation 512 and communicates the shipping information to the shipping carrier server at operation 514. In response, at operation 516, the antifraud shipping label application 122 receives a tracking number corresponding to an actual shipping label generated by the shipping carrier 406 based on the shipping information.

On the other hand, if the stamp is determined to be invalid at operation 510, the antifraud shipping label application 122 notifies the shipping carrier 406 of possible fraud at operation 518.

FIG. 5B shows a flow diagram illustrating another example embodiment of a method 501 for using antifraud shipping labels. The method 501 may be performed, in whole or in part, by the antifraud shipping label application 122, using modules discussed above with respect to FIG. 3.

At operation 503, the antifraud shipping label application 122 generates and mails a stamp having an identifier corresponding to the seller 402 registered with the marketplace application 120. At operation 505, the antifraud shipping label application 122 displays only a portion of the identifier of the stamp to the seller 402. At operation 507, the antifraud shipping label application 122 receives a request to use the stamp identified with the portion of the identifier from the seller 402. At operation 509, the antifraud shipping label application 122 receives data including the identifier of the stamp from a shipping carrier server. At operation 511, the antifraud shipping label application 122 validates the stamp and retrieves the shipping information corresponding to the stamp. At operation 513, the antifraud shipping label application 122 communicates the shipping information to the shipping carrier server. At operation 515, the antifraud shipping label application 122 receives tracking information from the shipping carrier 406. The tracking information corresponds to the stamp. The antifraud shipping label application 122 stores the relationship between the identifier of the stamp and the tracking information in a database.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware, may be a design choice. Below are set out hardware (e.g., machine) and software architectures that may be deployed, in various example embodiments.

### Example Computer System

FIG. 6 shows a diagrammatic representation of a machine in the example form of a computer system 600 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine 110 or 112 in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a UI navigation device 614 (e.g., a mouse), a disk drive unit 616, a signal generation device 618 (e.g., a speaker), and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., HTTP).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions 624. The term “machine-readable medium” shall also be taken to include any medium that is capable of storing, encoding, or carrying a set of instructions 624 for execution by the machine and that cause the machine to perform any one or more of the methodologies of the present disclosure, or that is capable of storing, encoding or carrying data structures utilized by or associated with such a set of instructions 624. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A shipping label system comprising:
at least one processor of a machine comprising a stamp generator and a stamp transaction registration module,
the stamp generator being configured to:
generate at least one of a plurality of stamps corresponding to a seller registered with an online marketplace application, each stamp comprising a unique identifier with respect to the online marketplace application, and
cause a mailing of the plurality of stamps to the seller;
the stamp transaction registration module being configured to:
generate a presentation in which the identifiers that correspond to the stamps mailed to the seller are each partially displayed within the presentation,
receive a selection of a partially displayed identifier as a selection made by the seller, and
associate shipping information from a transaction of the seller in the online marketplace application with the entirety of the partially displayed identifier selected by the seller.

2. The shipping label system of claim 1, wherein the at least one processor further comprises a shipping carrier stamp validator configured to:
receive an identifier of one of the plurality stamps from a shipping carrier,
validate the identifier received from the shipping carrier,
retrieve shipping information associated with the identifier received from the shipping carrier; and
communicate the retrieved shipping information to the shipping carrier.

3. The shipping label system of claim 2, wherein the shipping carrier stamp validator is configured to:
validate the identifier received from the shipping carrier by determining whether the identifier received from the shipping carrier has been selected by the seller for the transaction.

4. The shipping label system of claim 2, wherein the shipping carrier stamp validator is configured to:
validate the identifier received from the shipping carrier by determining whether the identifier received from the shipping carrier has already been identified in another transaction.

5. The shipping label system of claim 2, wherein the at least one processor further comprises a shipping carrier tracking number module configured to:
receive tracking information corresponding to the identifier received from the shipping carrier.

6. The shipping label system of claim 5, wherein the at least one processor further comprises a shipping carrier tracking number module configured to:
associate the tracking information with the identifier received from the shipping carrier.

7. The shipping label system of claim 5, wherein the shipping carrier tracking number module is configured to:
communicate the tracking information corresponding to the identifier received from the shipping carrier to the seller.

8. The shipping label system of claim 2, wherein the stamp transaction registration module is configured to:
identify the stamp identified by the identifier received from the shipping carrier; and
remove the identifier received from the shipping carrier from presentation to the seller.

9. The shipping label system of claim 2, wherein the shipping carrier stamp validator is configured to:
receive shipping charges information from the shipping carrier from which the identifier is received; and
communicate the shipping charges information to the online marketplace application to update a financial account of the seller.

10. The shipping label system of claim 2, wherein each indicator comprises a machine-readable code and corresponding alphanumeric characters, each without shipping information from the transaction, wherein the shipping information comprises an origin address and a destination address.

11. A method comprising:
generating, using at least one processor of a machine, at least one of a plurality of stamps corresponding to a seller registered with an online marketplace application, each stamp comprising a unique identifier with respect to the online marketplace application, and
causing a mailing of the plurality of stamps to the seller;
the stamp transaction registration module being configured to:
generating a presentation in which the identifiers that correspond to the stamps mailed to the seller are each partially displayed within the presentation,
receiving a selection of a partially displayed identifier as a selection made by the seller, and
associating shipping information from a transaction of the seller in the online marketplace application with the entirety of the partially displayed identifier selected by the seller.

12. The method of claim 11, further comprising:
receiving an identifier of one of the plurality stamps from a shipping carrier;
validating the identifier received from the shipping carrier;
retrieving shipping information associated with the identifier received from the shipping carrier; and
communicating the retrieved shipping information to the shipping carrier.

13. The method of claim 12, further comprising:
validating the identifier received from the shipping carrier by determining whether the identifier received from the shipping carrier has been selected by the seller for the transaction.

14. The method of claim 12, further comprising:
validating the identifier received from the shipping carrier by determining whether the identifier received from the shipping carrier has already been identified in another transaction.

15. The method of claim 12, further comprising:
receiving tracking information corresponding to the identifier received from the shipping carrier.

16. The method of claim 15, further comprising:
associating the tracking information with the identifier received from the shipping carrier;
communicating the tracking information corresponding to the identifier received from the shipping carrier to the seller.

17. The method of claim 12, further comprising:
identifying the stamp corresponding to the identifier received from the shipping carrier; and
removing the identifier received from the shipping carrier from presentation to the seller.

18. The method of claim 12, further comprising:
receiving shipping charges information from the shipping carrier from which the identifier is received; and
communicating the shipping charges information to the online marketplace application to update a financial account of the seller.

19. The method of claim 12, wherein each identifier comprises a machine-readable code and corresponding alphanumeric characters, each without shipping information from the transaction, without shipping information from the transaction, wherein the shipping information comprises an origin address and a destination address.

20. A non-transitory computer-readable storage medium storing a set of instructions that, when executed by a processor, cause the processor to perform operations, comprising:
generating at least one of a plurality of stamps corresponding to a seller registered with an online marketplace application, each stamp comprising a unique identifier with respect to the online marketplace application, and
causing a mailing of the plurality of stamps to the seller;
the stamp transaction registration module being configured to:
generating a presentation in which the identifiers that correspond to the stamps mailed to the seller are each partially displayed within the presentation,
receiving a selection of a partially displayed identifier as a selection made by the seller, and
associating shipping information from a transaction of the seller in the online marketplace application with the entirety of the partially displayed identifier selected by the seller.
